(19) United States
(12) Patent Application Publication
(10) Pub. No.: US 2009/0273780 A1
(43) Pub. Date: Nov. 5, 2009

(54) RAMAN SPECTRUM DETECTING METHOD AND RAMAN SPECTRUM DETECTING DEVICE

(75) Inventors: Yuichi Tomaru, Ashigara-kami-gun (JP); Naoki Murakami, Ashigara-kami-gun (JP); Masayuki Naya, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/434,147

(22) Filed: May 1, 2009

(30) Foreign Application Priority Data
May 1, 2008 (JP) 2008-119531

(51) Int. Cl. G01J 3/44

(52) U.S. Cl. 356/301

(57) ABSTRACT

A Raman spectrum detecting method includes a liquid sample contacting step of placing a liquid sample containing a reference substance and a specimen in contact with a detection surface, the reference substance generating a known Raman spectrum having at least one peak therein that is different from peaks in a Raman spectrum generated by the specimen; a scattered light detecting step of irradiating the detection surface in contact with the liquid sample with an excitation light and detecting Raman scattered light occurring from the liquid sample; and a normalizing step of extracting a Raman spectrum signal of the reference substance and a Raman spectrum signal of the specimen from the signal detected in the scattered light detecting step and normalizing a signal intensity of the Raman spectrum signal of the specimen according to an intensity of the Raman spectrum signal of the reference substance.

The entire contents of literature cited in this specification are incorporated herein by reference.

### BACKGROUND OF THE INVENTION

The present invention relates to a Raman spectrum detecting method and a Raman spectrum detecting device whereby a detection surface carrying a specimen thereon is irradiated by excitation light to generate enhanced fields on the detection surface in order to detect Raman scattered light of the specimen in the presence of the enhanced fields.

Raman spectroscopy is a method for separating Raman scattered light, which is obtained by radiating a substance with light having a single wavelength, into a spectrum of Raman scattered light and is used for identification of substances among other purposes. Raman spectroscopy may be used for measurement (e.g., identification) of biological samples and the like.

Further, the intensity of Raman scattered light may be used to detect the concentration and the quantity of a specimen because there is a correlation between the concentration of a specimen and the intensity of Raman scattered light thereof as described in JP 2000-258346 A in a passage about a method for quantitative analysis of substrates using Raman spectroscopy.

Generally, Raman scattered light obtained from a substance (specimen) provides only a feeble signal, which is difficult to detect with a high sensitivity.

On the other hand, JP 2005-172569 describes a method using a metallic nanostructure (or microsctructure) having a detection surface wherein numerous metallic particles having dimensions permitting excitation of localized plasmon resonance are provided to generate enhanced electric fields upon irradiation by light and thereby amplify Raman scattered light.

Thus, use of SERS (surface-enhanced Raman spectroscopy), which thus amplifies the intensity of the signal obtained from Raman scattered light by producing enhanced electric fields on the detection surface, permits detection of a specimen even when the specimen is scarce because of low concentration or for other reasons.

U.S. Pat. No. 6,888,629 describes a method for detecting a specimen using SERS whereby the other signals (second signals) than Raman scattered light are removed from the entire signals detected to extract the signal from Raman scattered light of the specimen. The U.S. patent states that the second signals are data stored in a processor and is detected in the absence of a specimen.

JP 2003-98090 A describes a method whereby a liquid substance emitting Raman scattered light that is different from that obtained from an analyte is attached to the analyte and then irradiated by light to measure Raman scattered light thereof. As described therein, the method produces effects of multiple reflection of light within the analyte and thus allows detection of a Raman spectrum having a great intensity.

### SUMMARY OF THE INVENTION

Where the specimen of interest is biological molecules, for example, the quantity and concentration thereof may be measured. In such cases, when one uses SERS whereby Raman scattered light is intensified by enhanced electric fields generated by a nanostructure, a significant variation in a single nanostructure or among nanostructures increases the variation in a signal or among signals obtained because the nanostructure determines the degree of intensity with which the signal is amplified. Accordingly, the intensified signal of Raman scattered light can vary according to the intensity of enhanced electric fields as obtained by each nanostructure used for measurement or depending upon the locations (regions) in a single nanostructure.

Such a variation in signal makes it difficult to quantitatively measure the quantity and concentration of a specimen.

Accordingly, a number of methods have been proposed to uniformly fabricate nanostructures but all of them fail to fabricate totally uniform nanostructures. Thus, there has been a limit to the uniformity of the signal intensity that could be achieved.

The method described in U.S. Pat. No. 6,888,629 is a method for detecting only a Raman spectrum of a specimen, and the patent therefore does not disclose quantitative measurement of a specimen. Even when the data stored in the processor is used, however, the detected value varies with each nanostructure, making quantitative measurement of a specimen difficult.

Supposing that Raman spectra attributable to other substances than the specimen can be removed, the degree with which the intensity is increased by enhanced electric fields cannot be detected. Thus, quantitative measurement of a specimen is difficult also for this reason.

JP 2003-98090 A describes a device achieving Raman spectroscopy using incident light having a small intensity without employing a nanostructure, and the device fails to restrict the variation in signal intensity responsible for inconsistency of SERS-active metallic nanostructure.

A method of causing multiple scattering using a liquid as described in JP 2003-98090 A presents a problem of a reduced measuring sensitivity because the Raman spectrum is intensified to a lower degree than when measurement is made by SERS.

Thus, an object of the present invention is to overcome the above problems associated with the prior art and provide a Raman spectrum detecting method and a Raman spectrum detecting device capable of quantitatively detecting the quantity of a specimen and the concentration thereof in a sample without regard to the degree of intensity with which the electric fields at the detection surface is enhanced.

A method of detecting a Raman spectrum according to a first aspect of the present invention comprises: a liquid sample contacting step of placing a liquid sample containing a reference substance and a specimen in contact with a detection surface, the reference substance generating a known Raman spectrum having at least one peak therein that is different from peaks in a Raman spectrum generated by the specimen; a scattered light detecting step of irradiating the detection surface in contact with the liquid sample with an excitation light and detecting Raman scattered light occurring from the liquid sample; and a normalizing step of extracting a Raman spectrum signal of the reference substance and a Raman spectrum signal of the specimen from the signal detected in the scattered light detecting step and normalizing a signal intensity of the Raman spectrum signal of the specimen according to an intensity of the Raman spectrum signal of the reference substance.

A method of detecting a Raman spectrum according to a second aspect of the present invention comprises: a first liquid sample contacting step of placing a first liquid sample containing a reference substance generating a known Raman spectrum in contact with a detection surface; a first scattered light detecting step of irradiating the detection surface in contact with the first liquid sample with an excitation light and detecting a first Raman scattered light occurring from the first liquid sample as a first Raman spectrum signal; a second liquid sample contacting step of placing a second liquid sample containing a specimen in contact with the detection surface;

a second scattered light detecting step of irradiating the detection surface in contact with the second liquid sample with the excitation light and detecting a second Raman scattered light occurring from the second liquid sample in and close to a same region, wherefrom the first scattered light is detected in the first scattered light detecting step, as a second Raman spectrum signal; and a normalizing step of normalizing a signal intensity of the second Raman spectrum signal of the specimen detected in the second scattered light detecting step according to a signal intensity of the first Raman spectrum signal of the reference substance detected in the first scattered light detecting step.

A device for detecting a Raman spectrum according to a third aspect of the present invention comprising: a substrate having a detection surface formed thereon that generates enhanced fields upon irradiation of an excitation light; liquid sample contacting means that places a liquid sample containing a reference substance and a specimen in contact with the detection surface of the substrate, the reference substance generating a known Raman spectrum having at least one peak therein that is different from peaks in a Raman spectrum generated by the specimen; light radiating means that irradiates the detection surface in contact with the liquid sample with the excitation light; a scattered light detecting means that detects the Raman scattered light occurring from the liquid sample irradiated by the excitation signal; and normalizing means that extracts the Raman spectrum signal of the reference substance and a Raman spectrum signal of the specimen from the signal obtained by the scattered light detecting means and normalizes a signal intensity of the Raman spectrum signal of the specimen according to an intensity of the Raman spectrum signal of the reference substance.

### BRIEF DESCRIPTION OF THE DRAWINGS

This and other objects, features, and advantages of the present invention will be apparent from the following detailed description and accompanying drawings in which:

FIG. 1 is a block diagram illustrating a schematic configuration of an embodiment of the Raman spectrum detecting device according to the invention.

FIG. 2 is a perspective view illustrating a schematic configuration of an embodiment of a microstructure used in the Raman spectrum detecting device illustrated in FIG. 1.

FIGS. 3A to 3C illustrate a process for producing a microstructure.

FIGS. 4A to 4C illustrate an embodiment of the Raman spectrum detecting method of the invention.

FIG. 5 is a flow chart illustrating a process for calculating the quantity or the concentration of a specimen using calculating means.

FIG. 6A is a perspective view illustrating a schematic configuration of another example of the microstructure; FIG. 6B is a partial top plan view of FIG. 6A.

FIG. 7 is a top plan view illustrating a schematic configuration of still another example of the microstructure.

FIG. 8A is a perspective view illustrating a schematic configuration of yet still another example of the microstructure; FIG. 8B is a sectional view of FIG. 8A.

### DETAILED DESCRIPTION OF THE INVENTION

Now, the Raman spectrum detecting method and the Raman spectrum detecting device of the invention will be described in detail by referring to the embodiments illustrated in the accompanying drawings.

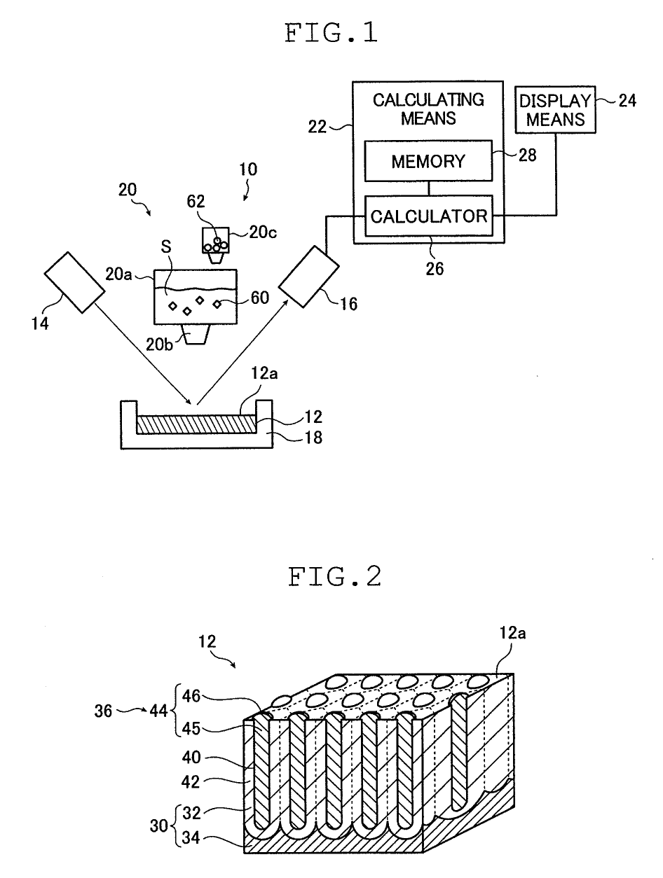

FIG. 1 is a block diagram illustrating a schematic configuration of a Raman spectrum detecting device 10, which is an embodiment of the invention; FIG. 2 is a perspective view illustrating a schematic configuration of a microstructure 12 used in the Raman spectrum detecting device 10 illustrated in FIG. 1.

As illustrated in FIG. 1, the Raman spectrum detecting device 10 comprises a microstructure 12, light radiating means 14 for irradiating the microstructure 12 with light, light detecting means 16 for detecting reflected light reflected by the microstructure 12, chip support means 18 for supporting the microstructure 12, liquid sample dropping means 20 for dropping onto the microstructure 12 a liquid sample S containing a specimen 60 and a given quantity of reference substance 62, calculating means 22 for extracting a Raman spectrum signal of the specimen 60 from the detection results given by the light detecting means 16 and a Raman spectrum signal of the reference substance 62 to normalize the Raman spectrum signal of the specimen, and display means for displaying the calculation results given by the calculating means 22.

The Raman spectrum detecting device 10 also comprises a housing for accommodating the microstructure 12, the light radiating means 14, the light detecting means 16 and the like; various optical components such as a filter for removing stray light occurring inside the Raman spectrum detecting device 10; a controller for controlling the operations performed by the Raman spectrum detecting device 10; and other various components necessary for the Raman spectrum detecting device 10, though not shown.

As illustrated in FIG. 2, the microstructure 12 comprises a substrate 30 and metallic members 36. The substrate 30 comprises a dielectric base 32 and an electric conductor 34 disposed on one surface of the dielectric base 32. The metallic members 36 are disposed in the surface of the dielectric base 32 opposite from the electric conductor 34.

The substrate 30 comprises the dielectric base 32 formed of a metallic oxide (Al₂O₃) and the electric conductor 34 disposed on the one surface of the dielectric base 32 and formed of a non-anodized metal (Al). The dielectric base 32 and the electric conductor 34 are formed integrally.

The dielectric base 32 has micropores 40 each having the shape of a substantially straight tubing that extends from the surface opposite from the electric conductor 34 toward the surface closer to the electric conductor 34.

Each of the micropores 40 is formed through the surface of the dielectric base 32 so as to have an opening at one end thereof opposite from the electric conductor 34, with the other end closer to the electric conductor 34 closing short of the opposite surface of the dielectric base 32. In other words, the micropores 40 do not reach the electric conductor 34. The micropores 40 each have a diameter smaller than the wavelength of the excitation light and are arranged regularly at a pitch smaller than the wavelength of the excitation light.

When the excitation light used is a visible light, the micropores 40 are preferably arranged at a pitch of 200 nm or less.

The metallic members 36 are formed of rods 44 each having a filler portion 45 and a projection (bulge) 46 above each micropore. The filler portion 45 fills the inside of each micropore 40 of the dielectric base 32. The projection 46 is formed on each micropore 40 so as to stick out from the surface of the dielectric base 32 and has dimensions capable of exciting localized plasmons with an outer diameter greater than that of the filler portion 45. The material for forming the metallic members 36 may be selected from various metals capable of generating localized plasmons and include, for example, Au, Ag, Cu, Al, Pt, Ni, Ti, and an alloyed metal thereof. Alternatively, the metallic members 36 may contain two or more of these metals. To obtain a further enhanced field effect, the metallic members 36 are more preferably formed using Au or Ag.

Preferably, the rods 44 of the metallic members 36 are so arranged that the projections 46 are spaced from each other by a distance of several tens of nanometers or less.

With the projections 46 spaced from each other by a distance of several tens of nanometers or less, highly enhanced electric fields can be generated when excitation light is radiated in regions where the projections 46 are in close proximity to each other. Such regions where highly enhanced electric fields are generated with the projections 46 spaced from each other by a distance of several tens of nanometers or less are called hot spots.

The microstructure 12 has a configuration as described above such that the surface on which the projections 46 of the rods 44 of the metallic members 36 are arranged is the surface with which the liquid sample S comes into contact, i.e., a detection surface 12a.

Now, the method of producing the microstructure 12 will be described.

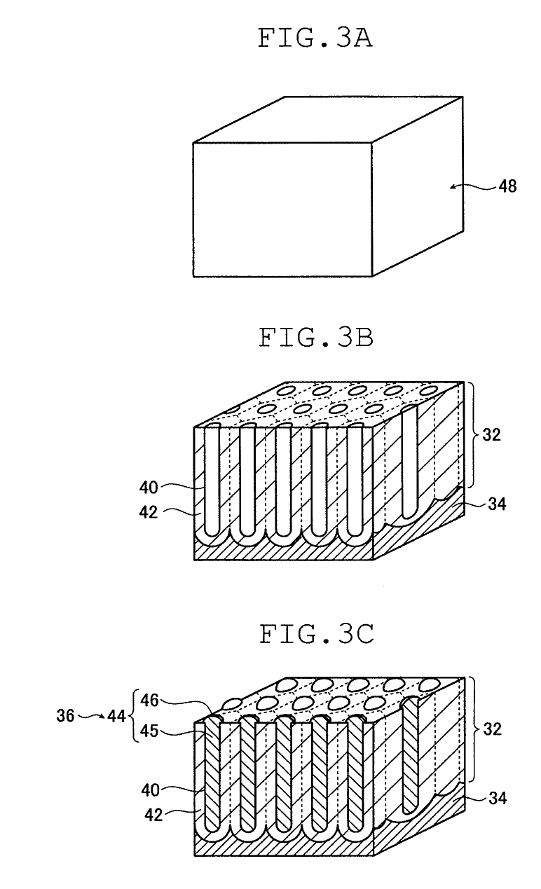

FIGS. 3A to 3C illustrate an example of the process for producing the microstructure 12.

First, a metallic body 48 to be anodized having the shape of a rectangular solid as illustrated in FIG. 3A is anodized. Specifically, the metallic body 48 to be anodized is immersed in an electrolytic solution as an anode together with a cathode, whereupon an electric voltage is applied between the anode and the cathode to achieve anodization.

The cathode may be formed, for example, of carbon or aluminum. The electrolytic solution is not limited specifically; preferably used is an acid electrolytic solution containing at least one of sulfuric acid, phosphoric acid, chromic acid, oxalic acid, sulfamic acid, benzenesulfonic acid and amidosulfonic acid.

Although the metallic body 48 to be anodized has the shape of a rectangular solid in this embodiment, the shape is not limited thereto and may vary. Further, one may use a configuration comprising a support member on which, for example, a layer of the metallic body 48 to be anodized is formed.

Anodization of the metallic body 48 causes oxidation to take place as illustrated in FIG. 3B from the surface of the metallic body 48 to be anodized in a direction substantially vertical to that surface, producing a metallic oxide (Al₂O₃), which is used as the dielectric base 32. The metallic oxide produced by anodization or the dielectric base 32 has a structure wherein numerous minute columns 42 each having a substantially hexagonal shape in planar view are arranged leaving no space between them.

The minute columns 42 each have a round bottom end and a micropore 40 positioned substantially at its center and extending straight from the top surface in the depth direction, i.e., in the direction of the axis of each minute column 42. For the structure of a metallic oxide produced by anodization, reference may be had, for example, to “Production of Mesoporous Alumina using Anodizing Method and Applications Thereof as Functional Material” by Hideki Masuda, page 34, Zairyo Gijutsu (Material Technology), Vol. 15, No. 10, 1997.

An example of preferred anodization conditions for producing a metal oxide having a regularly arrayed structure includes an electrolytic solution having a concentration of 0.5 M, a liquid temperature in the range of 14° C. to 16° C., and an applied electric voltage of 40 V to 40 V±0.5 V among other conditions when using oxalic acid as an electrolytic solution. The micropores 40 produced under these conditions each have, for example, a diameter of about 30 nm and are arranged at a pitch of about 100 nm.

Next, the micropores 40 of the dielectric base 32 are electroplated to form the rods 44 each having the filler portion 45 and the projection 46 as illustrated in FIG. 3C.

In the electroplating, the electric conductor 34 acts as an electrode, causing a metal to be deposited preferentially from the bottoms of the micropores 40 where the electric field is stronger. Continuous electroplating causes the micropores 40 to be filled with a metal, forming the filler portions 45 of the rods 44. Electroplating further continued after the formation of the filler portions 45 causes the metal to overflow from the micropores 40. However, the electric field near the micropores 40 is so strong that the metal continues to be deposited around each micropore 40 until the metal is deposited above the filler portions 45 so as to project from the surface of the dielectric base 32, thus forming the projections 46 having a diameter greater than that of the filler portions 45.

Since the microstructure 12 according to the above embodiment is produced using anodization, it is easy to produce the microstructure 12 where the micropores 40 of the dielectric base 32 and the projections 46 of the metallic members 36 are arranged substantially regularly. Alternatively, the micropores may be arranged randomly.

Although only Al is cited as a major component of the metallic body 48 to be anodized that is used to produce the dielectric base 32 in the above embodiment, any metal having a translucency may be used, provided that it is anodizable and that the resulting metallic oxide is translucent. Other metals than Al that may be used include Ti, Ta, Hf, Zr, Si, In, and Zn. The metallic body 48 to be anodized may contain two or more kinds of anodizable metals.

This is how the microstructure 12 is produced.

The light radiating means 14 comprises a light source such as laser light source and a light guiding system for guiding excitation light Le emitted from the light source. The light radiating means 14 emits the light (excitation light) Le having a specific wavelength to irradiate the detection surface of the microstructure 12 with the excitation light Le.

The light detecting means (i.e., dispersing means) 16, which may be formed, for example, of a spectroscope or the like, is provided in a position where scattered light occurring at the detection surface of the microstructure 12 upon irradiation by excitation light from the light radiating means 14 enters.

The light detecting means 16 separates the scattered light occurring at the detection surface 12a of the microstructure 12 into a spectrum to detect the Raman scattered light as Raman spectrum signal.

The chip support means 18 is a seating or the like and holds the microstructure 12 in a given position by supporting the microstructure 12 from the side thereof bearing the electric conductor 34. The chip support means 18 comprises an enclosure for covering the outer periphery of the lateral sides of the microstructure 12 to prevent a liquid from spilling out from the surface of the microstructure 12 when the liquid is dropped onto the microstructure 12.

The liquid sample dropping means 20 comprises a reservoir 20a for storing the liquid sample S containing a specimen 60, a dropping member 20b for dropping the liquid sample S stored in the reservoir 20a onto the microstructure 12, and a reference substance mixer 20c for mixing a given quantity of a reference substance 62 into the reservoir 20a. The liquid sample dropping means 20 is disposed opposite the detection surface of the microstructure 12.

The reservoir 20a is a container for storing the liquid sample S containing the specimen 60. The reservoir 20a stores a given quantity of the liquid sample S.

When the specimen 60 is a substance that is not contained in a liquid, the specimen 60 may be dispersed in a solvent to prepare the liquid sample S. The solvent for dispersing the specimen may be any of various solvents such as water, ethanol, and aqueous solutions containing a substance selected from a variety of substances, such as an aqueous solution of citric acid. In this embodiment, a volatile solvent is preferably used and specifically ethanol.

The dropping member 20b drops a given quantity of the liquid sample S stored in the reservoir 20a onto the microstructure 12. The dropping member 20b may be a dropper, for example.

The reference substance mixer 20c holds a reference substance 62 having known properties and mixes a given quantity of the reference substance 62 into the reservoir 20a. The reference substance mixer 20c may hold the reference substance in the state of solid or liquid.

The reference substance 62 is a substance having a known Raman spectrum and emits a Raman spectrum having one or more peak wavenumbers that are different from the peak wavenumbers of the Raman spectrum of the specimen 60 (to be more precise, a substance that can be detected as specimen 60). In other words, the reference substance is a substance that emits Raman scattered light having wavenumbers that are not shared by Raman scattered light emitted from the specimen 60. The reference substance may be any of various substances causing Raman scattered light to occur such as PBS, HBS, dimethylsulfoxide (DMSO) having a key band of 670 cm⁻¹, dimethylsulfoxide (DMSO) having a key band of 680 cm⁻¹, and R6G having a key band of 1360 cm⁻¹.

The liquid sample dropping means 20, having a configuration as described above, mixes a given quantity of the reference substance into the liquid sample S stored in the reservoir 20a and then drops a given quantity of the liquid sample S through the dropping member 20b onto the detection surface 12a of the microstructure 12.

The calculating means 22 comprises a calculator 26 for performing computation on the data supplied from the light detecting means 16 and a memory 28 for storing data supplied from the light detecting means 16, computation results done by the calculator 26, Raman spectra of, and specific to, reference substances, and the like. The calculating means 22 extracts and normalizes the Raman spectrum signal of the specimen from the Raman spectrum signals detected by the light detecting means 16 and identifies the specimen from the normalization results to work out the quantity or the concentration of the specimen.

The display means 24 is a device such as a liquid crystal display for displaying images and displays calculation results and Raman spectra, and the like sent from the calculating means 22.

The Raman spectrum detecting device 10 basically has the configuration as described above.

Now, the Raman spectrum detecting device and the specimen detecting method according to the invention will be described in greater detail by describing operations of the Raman spectrum detecting device 10.

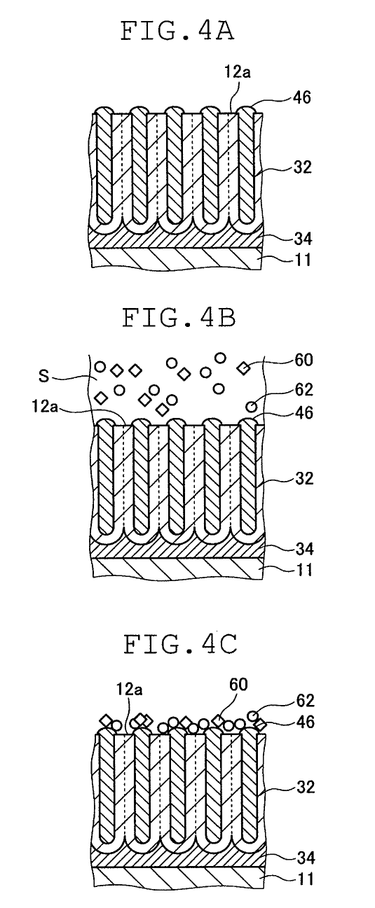

FIGS. 4A to 4C illustrate an embodiment of the method for detecting a specimen according to the invention.

First, the microstructure 12 is placed at a given position in the support means 18.

The liquid sample dropping means 20 drops a given quantity of the reference substance 62 from the reference substance mixer 20 into the liquid sample S having a given quantity and stored in the reservoir 20a. As a result, the reference substance 62 having known properties (specifically, Raman spectrum) is mixed into the reservoir 20a with a known concentration and the liquid sample S containing the specimen 60, which is the subject of detection, is prepared.

Next, the liquid sample S is dropped from the liquid sample dropping means 20 onto the detection surface 12a of the microstructure 12 as illustrated in FIG. 4A.

Thus, the liquid sample S is now kept and held by the microstructure 12 and the support means 18 in such a manner that the liquid sample S containing the specimen 60 and the reference substance 62 is in contact with the detection surface 12a of the microstructure 12 as illustrated in FIG. 4B.

Then, the detection surface 12a is dried to remove the liquid component (solvent) of the liquid sample in contact therewith. Thus, the specimen 60 and the reference specimen 62 are attached to the periphery of the projections 46 as illustrated in FIG. 4C.

Next, the excitation light is emitted from the light emitting means 14 to irradiate the detection surface 12a to which the specimen 60 and the reference substance 62 are attached.

When the detection surface 12a of the microsctructure 12 is irradiated by the light emitted from the light emitting means 14, localized plasmons are generated at the surfaces of the projections 46 of the metallic members 36 to generate enhanced electric fields.

Further, the microsctructure 12 effectively generates also localized plasmon resonance that further enhances the electric fields at the surfaces of the projections 46 of the metallic members 36. The localized plasmon resonance is a phenomenon where the electric fields are further enhanced as free electrons of a metal in a localized collective motion caused by localized plasmons oscillate in resonance with the optical electric fields. In the irregular configuration of the microstructure 12 formed by the projections 46 (bulges), free electrons of the projections 46 oscillate in resonance with the optical electric fields in regions where the wavelength of an incident light agrees with the dimensions of the irregular configuration, and the incident light is efficiently converted into electric fields thereby to further enhance the electric fields around the projections 46.

Thus, the microstructure 12 achieves a high field enhancement effect at the detection surface 12a of the microstructure 12, creating enhanced electric fields. Although it is preferable to design and adjust the wavelength of the excitation light and the dimensions of the projections of the microstructure 12 in such a manner as to cause localized plasmon resonance at the projections in order to achieve a further enhanced electric field, localized plasmons need only be generated at least at the projections.

The specimen 60 and the reference substance 62 on the detection surface 12a generate their respective Raman scattered light upon incidence of excitation light having a specific wavelength. The respective Raman scattered light generated by the specimen 60 and the reference substance 62 is enhanced by the electric fields generated by the localized plasmons. That is, Raman scattered light is intensified by Raman enhancement effect. The spectrum of Raman scattered light emitted from the specimen 60 varies with the kind of sample to be detected.

The light detection means 16 disperses the scattered light occurring at the detection surface 12a of the microstructure 12 and detects the signal of the spectrum (Raman spectrum) of the Raman scattered light. Subsequently, the signal of the detected Raman spectrum is sent to the calculating means 22.

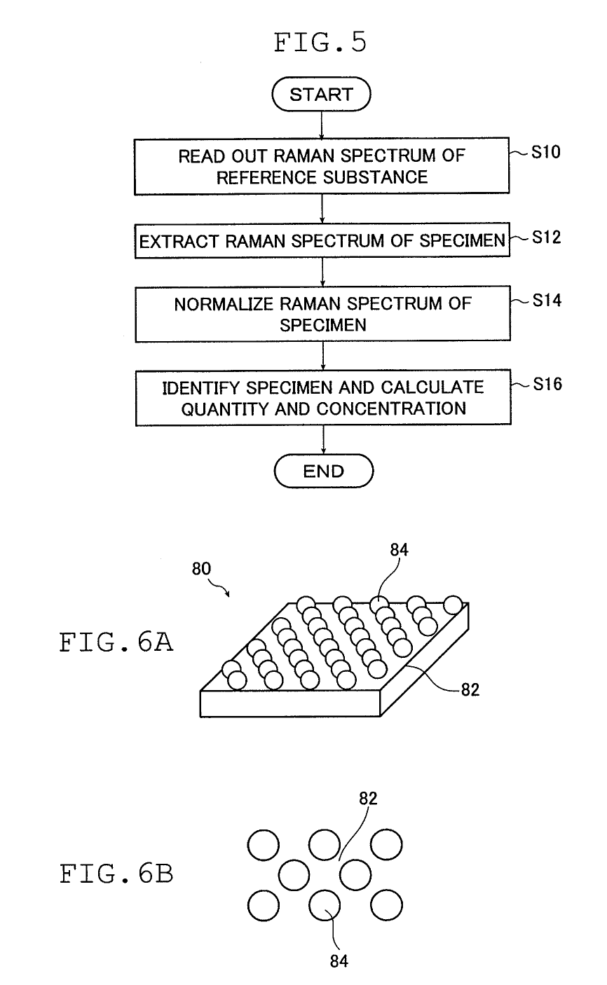

FIG. 5 is a flow chart illustrating a process for calculating the quantity or the concentration of the specimen using the calculating means 22.

In the calculating means 22, the calculator 26 first reads out the waveform of the Raman spectrum of the reference substance 62 from the memory 28 according to the information on the reference substance 62 mixed in the reference substance mixer 20c (step S10).

Then, the Raman spectrum signal attributable to the read-out reference substance 62 is removed from the detected Raman spectrum signal to extract the Raman spectrum signal attributable to the specimen 60 (step S12). Specifically, the detected Raman spectrum signal is matched with the Raman spectrum signal attributable to the read-out reference substance 62 in respect of the peak wavenumbers, spectrum distributions, and the like, whereupon the Raman spectrum signal attributable to the reference substance is removed from the detected Raman spectrum signal in wavelength ranges where they overlap in order to extract the Raman spectrum signal attributable to the specimen 60.

Next, the Raman spectrum signal attributable to the specimen 60 is normalized according to the results obtained by matching the detected Raman spectrum signal and the read-out Raman spectrum signal of the reference substance 62 (step S14). Specifically, the signal intensity of the Raman spectrum signal extracted from the detected Raman spectrum signal and attributable to the specimen 60 is normalized according to the relationship between the signal intensity of the Raman spectrum signal of the reference substance contained in the detected Raman spectrum signal and the known concentration of the reference signal.

Next, the normalized Raman spectrum signal attributable to the specimen 60 is compared with the Raman spectra of various substances stored in the memory 28 to identify the kind of the specimen of interest and, moreover, the quantity and the concentration of the specimen are calculated according to the normalized Raman spectrum signal (step S16). Further, the concentration can be calculated by tempering it with the quantity of the liquid sample dropped from the liquid sample dropping means 20.

The kind, the quantity, and the concentration of the specimen obtained by the calculating means 22 are displayed by the display means 24.

Thus, the Raman spectrum detecting device 10 identifies the specimen and works out the quantity and the concentration thereof.

Thus, the Raman spectrum detecting device 10 can normalize the signal intensity of the Raman spectrum of the specimen 60 according to the signal intensity of the Raman spectrum of the reference substance 62 by mixing a given quantity of the reference substance 62 having a known Raman spectrum into the liquid sample S.

Accordingly, a high-accuracy quantitative detection of a specimen is made possible even where there is a variation in the projections formed on the detection surface of the microstructure, causing a variation among microstructures in the enhanced electric fields they generate and uneven intensities of Raman scattered light generated by SERS.

Further, use of the reference substance 62 that generates a Raman spectrum having one or more peaks that are different from the peaks in the Raman spectrum of the specimen 60 makes it possible to extract both the Raman spectrum of the reference substance 62 and the Raman spectrum of the specimen 60 without one of them being mixed with the other.

Further, the high-accuracy quantitative detection achieved without regard to possibly unevenly enhanced electric fields at the detection surface of the microstructure allows the use of a microstructure having uneven enhanced electric fields occurring at the detection surface, i.e., a microstructure generating enhanced electric fields having different intensities. This increases the range of tolerances of the microstructure that can be used and, hence, the production yield, thus reducing the manufacturing costs.

Now, the present invention will be described in greater detail by referring to specific examples.

The example now to be described uses a specimen being adenine having a key band of 730 cm⁻¹ and a reference substance being DMSO having a key band of 680 cm⁻¹. In this example, the DMSO having a known concentration serves also as the solvent of the liquid sample S. The concentration of adenine in the liquid sample was 100 μM.

The microstructure used in the example was the microstructure 12 having the configuration as illustrated in FIG. 2. The light radiating means 14 was a semiconductor laser having an output power of 2 mW and an excitation wavelength of 633 nm. The light detecting means 16 was a LabRam HR-800 Micro-Raman-Spectrometer manufactured by Horiba Jobin-Yvon.

In this example, the signal intensities for 730 cm⁻¹ and 680 cm⁻¹ were measured at nine measuring points 1 to 9 on one detection surface. That is, measurements were made at nine measuring points using a liquid sample containing the same concentration of the specimen and the reference substance.

Further, the signal intensity for 730 cm⁻¹ was normalized with the signal intensity for 680 cm⁻¹ to work out a normalized value for each measuring point using the calculated signal intensities for 730 cm⁻¹ and 680 cm⁻¹.

Further worked out were the average signal intensity for 730 cm⁻¹ at the nine measuring points, the standard deviation calculated from only the signal intensity for 680 cm⁻¹, the average of the values obtained by normalizing the signal intensity for 730 cm⁻¹ with the signal intensity for 680 cm⁻¹, and the standard deviation.

Table 1 shows the measurement results and the calculation results.

TABLE 1

| | SIGNAL INTENSITIES | | | DEVIATION OF | DEVIATION |
|---|---|---|---|---|---|
| | ADENINE | DMSO | AFTER | INTENSITY FOR | AFTER |
| | 730 cm⁻¹ | 680 cm⁻¹ | NORMALIZATION | 730 cm⁻¹ ONLY | NORMALIZA [symbol] |
| MEASURING POINT 1 | 860 | 444 | 1.937 | 1.100 | 1.186 |
| MEASURING POINT 2 | 743 | 425 | 1.748 | 0.950 | 1.071 |
| MEASURING POINT 3 | 1416 | 600 | 2.360 | 1.810 | 1.445 |
| MEASURING POINT 4 | 636 | 534 | 1.191 | 0.813 | 0.729 |
| MEASURING POINT 5 | 810 | 583 | 1.389 | 1.036 | 0.851 |
| MEASURING POINT 6 | 751 | 354 | 2.121 | 0.960 | 1.299 |
| MEASURING POINT 7 | 452 | 363 | 1.245 | 0.578 | 0.763 |
| MEASURING POINT 8 | 715 | 463 | 1.544 | 0.914 | 0.946 |
| MEASURING POINT 9 | 656 | 566 | 1.159 | 0.839 | 0.710 |
| AVERAGE | 782.11 | | 1.633 | | |
| VARIATION | | | | 0.339 | 0.266 |

[symbol]

indicates data missing or illegible when filed

As Table 1 shows, normalizing the signal intensity (signal intensity for 730 cm⁻¹) of adenine (specimen) with the signal intensity (signal intensity for 680 cm⁻¹) of DMSO (reference substance) makes quantitative calculation of the specimen without regard to the signal intensity of the specimen. In other words, using a reference substance having a known concentration enables quantitative calculation without regard to the magnitude of the signal intensity. Thus, quantitative measurement of a specimen is made possible without regard to the intensity of Raman scattered light generated by the microstructure.

Specifically, the signal intensities measured vary with the degree of enhancements that vary depending upon the measuring points even in the same specimen having a given concentration; the signal intensity is 452 at the measuring point 7 and 1416 at the measuring point 3. On the other hand, when the normalization is effected with the signal intensity of the reference substance, the measurements obtained are 1.245 at the measuring point 7 and 2.360 at the measuring point 3. Thus, the difference can be reduced as compared with a case where simply the signal intensity of the specimen is measured.

It is apparent from the above that even where the signal intensity varies depending upon the degree of enhancement of the microstructure, normalization allows the degree of enhancement of the microstructure to be tempered with a reference substance having a known concentration, thus making a quantitative measurement possible.

Further, normalization using a reference substance can also reduce the variation. Specifically, the variation in the standard deviation can be reduced from 0.399 to 0.266.

The effects produced by the invention are obvious from the foregoing description.

Preferably, the reference substance 62 is a substance that is different from the specimen 60 also in full-width at half-maximum of the Raman spectrum. Using the reference substance 62 generating one or more Raman spectrum peak wavenumbers that are different from those of the specimen 60 and containing peaks having different full-widths at half-maximum allows a yet more accurate extraction of the signal of the Raman spectrum attributable to the reference substance 62 and the signal of the Raman spectrum attributable to the specimen 60 from the signals of the Raman spectra detected by the light detecting means 16.

Preferably, the reference substance 62 generates a Raman spectrum having peak wavenumbers that are different from those of the Raman spectrum generated by the specimen 60 by a factor of two or more in terms of full-width at half-maximum. The difference in peak wavenumbers between both substances by a factor of two or more in terms of full-width at half-maximum allows the Raman spectra to be extracted with an increased precision.

Preferably, the reference substance 62 is a substance that generates a Raman spectrum having about the same degree of intensity as that of the specimen 60. Using the reference substance 62 and the specimen 60 each generating a Raman spectrum having a comparable intensity allows a yet more accurate normalization of the signal intensity of the Raman spectrum of the specimen 60.

Preferably, the reference substance mixer 20c comprises a plurality of different reference substances 62 to allow selection of the reference substance 62 for mixing into the liquid sample S according to the kind (spectral intensity, wavenumber) of the specimen 60 (or a substance assumed to be the specimen 60).

Thus, selection of the reference substance allows more appropriate extraction and normalization of the Raman spectrum signal of the specimen and enables a quantitative detection of the specimen with an increased accuracy.

An optimum reference substance may be determined according to a detection value obtained by detecting the Raman spectrum signal of the specimen without the reference substance mixed therewith. This allows a more appropriate selection of the reference substance.

Preferably, the Raman spectrum detecting device 10 is so configured that a specific binding substance is secured to the projections 46 of the microstructure 12.

When a specific binding substance is disposed on the projections of the microstructure, a specific specimen (i.e., a specimen having a disposition to bind to the specific binding substance) can be bound to the projections of the microstructure.

In this case, it is preferable to provide two kinds of specific binding substance: a specific binding substance specifically binding to the specimen and a specific binding substance specifically binding to the reference substance. Providing different specific binding substances for the specimen and the reference substance precludes the possibility that one of the substances fails to bind because of the other, which would otherwise cause a discrepancy between the detected value and the actual value.

Where the specimen 60 and the reference substance 62 are bound to one kind of specific binding substance, one of the specimen 60 and the reference substance 62 preferably does not have an excessively greater binding force than the other substance with respect to the specific binding substance in order to ensure that the specimen 60 and the reference substance 62 are attached to the specific binding substance with about the same degree of force (that is, the binding force ratio should lie in a given range).

The specific binding substances that may be used herein are as follows.

Where the specimen is at least one kind selected from the group consisting of protein, peptide, and amino acid, the specific binding substance that ionically binds with the specimen may be a surface-modifying group having an opposite charge from that of the specimen, and the surface-modifying group may be exemplified by a carboxy group, a sulfonic acid group, a phosphoric acid group, an amino group, a quaternary ammonium group, an imidazole group, a guanidinium group, and a derivative group thereof. The projections may have two or more kinds of these surface-modifying groups.

Where the specimen is at least one kind selected from the group consisting of protein, peptide, and amino acid, the specific binding substance that covalently binds with the specimen may be a surface-modifying group exemplified by a reactive ester group such as an N-hydroxysuccinimidyl ester, a carbodiimide group, a 1-hydroxybenzotriazole group, a hydrazide group, a thiole group (sulfanyl group), a reactive disulfide group, a maleimide group, an aldehyde group, an epoxide group (epoxy group), a (meta)acrylate group, a hydroxyl group (hydroxy group), an isocyanate group, an isothiocyanate group, and a derivative group thereof. The projections may have two or more kinds of these surface-modifying groups.

Preferably used as the specific binding substances herein are a reactive ester group, a hydrazide group, a thiole group (sulfanyl group), and a reactive disulfide group, among the above examples of the surface-modifying group.

The word “reactive” used above means having a reactivity with the specimen.

It is particularly preferable to attach to the projections both a specific binding substance that ionically binds with the specimen and a specific binding substance that covalently binds with the specimen.

In this case, a specific binding substance that ionically binds with the specimen and a specific binding substance that covalently binds with the specimen may be attached to the projections simultaneously or sequentially. The positions of the surface modification by these specific binding substances are not specifically limited; the specific binding substances may bind with each other or bind with the projections independently from each other.

It is also particularly preferable to secure the specific binding substance that ionically binds with the specimen to the projections and activate this specific binding substance with the specific binding substance that covalently binds with the specimen.

For example, it is preferable that a carboxy group that ionically binds with the specimen is first introduced to the projections and the introduced carboxy group is induced into a mode of a functional group such as a reactive ester group, a hydrazide group, a thiole group, and a disulfide group that covalently binds with the specimen to achieve activation.

Since the specific binding substance that ionically binds with the specimen and the specific binding substance that covalently binds with the specimen come close to each other, each piece of the specimen can be firmly adsorbed onto the surfaces of the projections by virtue of ionic bond and covalent bond.

A specific binding substance containing both a surface-modifying group that ionically binds with the specimen and a surface-modifying group that covalently binds with the specimen may be exemplified by molecules that form self-assembled films such as 4,4-dithiodibutyl acid (DDA), 10-carboxy-1-decane thiole, 11-amino-1-undecane thiole, 7-carboxy-1-heptanthiol, 16-mercaptohexadecanoic acid, 11,11′-thiodiundecanoic acid; hydrogels such as agarose, dextran, carrageenin, alginic acid, starch, and cellulose or derivatives thereof (e.g., carboxymethyl derivative); and water swellable organic polymers such as polyvinyl alcohol, polyacrylic acid, polyacrylamide, and polyethyleneglycol.

For example, when the specimen is adenine, 4,4-dithiodibutyl acid (DDA) and carboxymethyl dextran (CMD) are among the substances preferably used as a specific binding substance containing both a surface-modifying group that tonically binds with the specimen and a surface-modifying group that covalently binds with the specimen.

Various means may be used to dry the detection surface 12a after placing the liquid sample S in contact with the detection surface 12a of the microstructure 12; the detection surface 12a may be left a given length of time after dropping to dry naturally, or heating means for drying the detection surface may be provided to actively cause the solvent to evaporate.

With the Raman spectrum detecting device 10, the detection surface 12a need not necessarily be dried when detecting Raman scattered light; the detection surface 12a may be wet. In other words, the solvent component of the liquid sample S may be in contact with the detection surface 12a when detecting Raman scattered light.

Where, in particular, the specimen and the reference substance, when dry, react and become another substance, it is preferable that Raman scattered light is detected with the solvent of the liquid sample S in contact with the detection surface 12a.

With the Raman spectrum detecting device 10, the reference substance 62 is mixed into the liquid sample S to simultaneously detect the Raman spectrum signals of the specimen and the reference substance in the same region of the detection surface. However, the Raman spectrum signals of the specimen and the reference substance may be detected separately.

For example, a liquid containing a given concentration of reference substance may be placed in contact with the detection surface to detect the Raman spectrum signal of the reference substance, thereafter placing the liquid sample S in contact with the detection surface to detect the Raman spectrum signal of the specimen. Conversely, the liquid sample S may be first placed in contact with the detection surface to have detected the Raman spectrum signal of the specimen, thereafter placing the liquid containing a given concentration of the reference substance in contact with the detection surface to detect the Raman spectrum signal of the reference substance. In this case, the Raman spectrum detecting device needs to have a reservoir for keeping the liquid sample S and another reservoir for holding the liquid containing the reference substance separately.

In this case also, the intensity of the enhanced electric field on the detection surface in the region where the Raman spectrum signal of the specimen is detected can be normalized according to the Raman spectrum signal of the reference substance. Thus, normalizing the Raman spectrum signal of the specimen according to the Raman spectrum signal of the reference substance allows a quantitative detection of the specimen to be achieved with an increased accuracy.

Where the Raman spectrum signals of the specimen and the reference substance are detected separately, the substance detected later preferably has a greater binding force than the substance detected earlier with respect to the projections or the specific binding substance. Thus, residue, if any, of the earlier detected substance on the detection surface can be replaced by the later detected substance at the time of detection of the latter and, therefore, the later detected substance can be detected more accurately.

Thus, even when the liquid containing the later detected substance is dropped onto the detection surface where there is residue of the liquid containing the earlier detected substance, the Raman spectrum signal of the later detected substance can be detected appropriately.

The shape of the microstructure is not limited to that of the microstructure 12; the microstructure may have various other shapes, provided that the microstructure has projections formed on the substrate thereof each having dimensions permitting excitation of localized plasmon.

FIG. 6A is a perspective view illustrating a schematic configuration of another example of the microstructure; FIG. 6B is a top plan view of FIG. 6A.

A microstructure 80 illustrated in FIGS. 6A and 6B comprises a substrate 82 and numerous metallic particles 84 disposed on the substrate 82.

The substrate 82 is a base material in the form of a plate. The substrate 82 may be formed of a material capable of supporting the metallic particles 84 in an electrically insulated state, the material thereof being exemplified by silicon, glass, yttrium-stabilized zirconia (YSZ), sapphire, and silicon carbide.

The numerous metallic particles 84 are each of dimensions permitting excitation of localized plasmons and held in position such that they are spread on one surface of the substrate 82.

The metallic particles 84 may be formed of any of the metals cited above for the metallic members 36. Further, the metallic particles 84 may be formed of the same metal as or a different metal from the one used to form the metallic particles 62 described earlier. The shape of the metallic particles is not limited specifically; it may be a sphere or a rectangular solid.

The microstructure 80 having such a configuration also generates localized plasmons around the metallic particles and generates enhanced electric fields when the detection surface on which the metallic particles are disposed is irradiated by the excitation light.

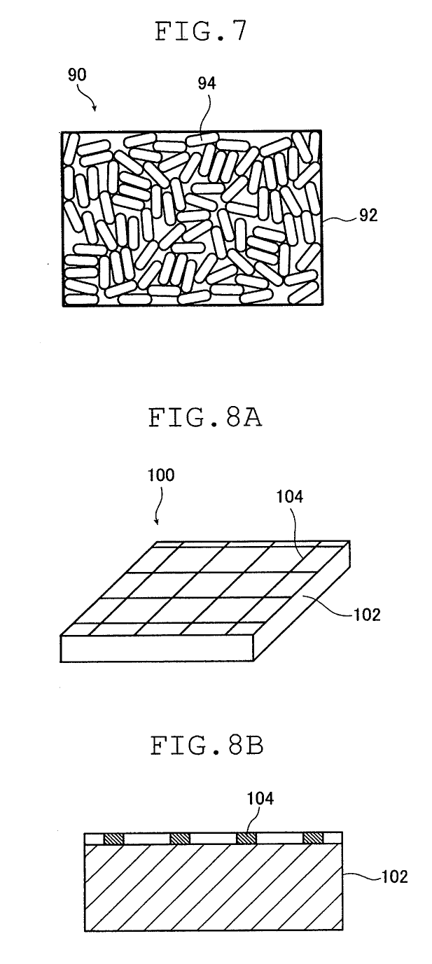

FIG. 7 is a top plan view illustrating a schematic configuration of still another example of the microstructure.

A microstructure 90 illustrated in FIG. 7 comprises a substrate 92 and numerous metallic nanorods 94 disposed on the substrate 92.

The substrate 92 has substantially the same configuration as the substrate 82 described earlier, and therefore detailed description thereof will not be given here.

The metallic nanorods 94 are metallic nanoparticles each having dimensions permitting excitation of localized plasmons and each shaped like a rod having a minor axis and a major axis different in length from each other. The metallic nanorods 94 are distributed and secured to one surface of the substrate 92. The minor axis of the metallic nanorods 94 measures about 3 nm to 50 nm, and the major axis measures about 25 nm to 1000 nm. The major axis is smaller than the wavelength of the excitation light. The metallic nanorods 94 may be formed of the same metal as the metallic particles described above. For details of the configuration of metallic nanorods, reference may be had, for example, to JP 2007-139612 A.

The microstructure 90 may be produced by the same method as described above for the microstructure 80.

The microstructure 90 having such a configuration also generates localized plasmons around the metallic nanorods and generates enhanced electric fields when the detection surface on which the metallic nanorods are disposed is irradiated by the excitation light.

Thus, also where the microstructure 90 having the above configuration is used, the microstructure can be likewise fabricated as when using the microstructure 12 and the microstructure 80 and, furthermore, the specimen can be detected with a high sensitivity.

Now, reference is made to FIG. 8A, which is a perspective view illustrating a schematic configuration of yet still another example of the microstructure; FIG. 8B is a sectional view of FIG. 8A.

A microstructure 100 illustrated in FIG. 8 comprises a substrate 102 and numerous thin metallic wires 104 provided on the substrate 102.

The substrate 102 has substantially the same configuration as the substrate 82 described earlier, and therefore detailed description thereof will not be given here.

The thin metallic wires 104 are linear members each having a line width permitting excitation of localized plasmons and arranged like a grid on one surface of the substrate 102. The thin metallic wires 104 may be formed of the same metal as the metallic particles and the metallic members described earlier. The thin metallic wires 104 may be produced by any of various methods used to produce metallic wiring including but not limited to vapor deposition and plating.

Specifically, the line width of the thin metallic wires 104 is preferably 50 nm or less, and preferably 30 nm or less. The thin metallic wires 104 may be arranged in any pattern as appropriate, which is not specifically limited. For example, the thin metallic wires 104 may be arranged in a pattern where the thin metallic wires do not cross each other, i.e., are parallel to each other. The thin metallic wires are also not limited in shape to straight lines and may be curved lines.

The microstructure 100 having such a configuration also generates localized plasmons around the thin metallic wires and generates enhanced electric fields when the detection surface on which the thin metallic wires are arranged is irradiated by the excitation light.

Thus, also when the microstructure 100 having the above configuration is used, the microsctructure can be likewise produced as when using the microstructure 12, the microstructure 80, and the microstructure 90 and, furthermore, the specimen can be detected with a high sensitivity.

Further, the microstructure is not limited to the microstructure 12, the microstructure 80, the microstructure 90, or the microstructure 100; the microstructure may have a configuration comprising projections capable of exciting localized plasmons from each of these microstructures.

Further, where the metallic particles are formed by vapor-deposition on the substrate, the vapor deposition on the substrate may be effected from various directions.

Preferably, the microstructure is so constructed that the metallic particles are first disposed on the substrate, followed by vapor deposition of a metallic film on the substrate to form the projections. Thus, when the metallic film is vapor-deposited after the metallic particles are disposed, the metallic film can be formed between the metallic particles (fine metallic particles) so that the metallic particles and the metallic film can be placed in close contact, and thus the number of hot spots on the detection surface of the microstructure can be increased.

Although the liquid sample is dropped onto the microstructure using the liquid sample dropping means in the above embodiment, the invention is not limited thereto; a flow channel for supplying the liquid sample may be formed in the surface of the microstructure to allow the liquid sample to flow through this flow channel and thereby supply the liquid sample to the detection surface (that is, the liquid sample may be placed in contact with the detection surface this way).

Note that the embodiments of the Raman spectrum detecting method and the Raman spectrum detecting device of the invention described above in detail are only illustrative and not restrictive of the invention and that various improvements and modifications may be made without departing from the spirit of the invention.

For example, although it is the peaks in the wavenumber distribution that are detected as the peaks in the Raman spectrum in the above embodiment, the requirements are that at least the bright lines (projections) in the distribution are detected and therefore the peaks in the wavelength distribution may be detected. For example, although the entire wavelength is detected as Raman spectrum in the above embodiment, the invention is not limited thereto; only the parts of the waveform corresponding to the peaks may be detected as Raman spectrum. That is, the entire wavelength need not necessarily be used but only the peaks may be used to detect the Raman spectrum.

According to the invention, the Raman spectrum of a specimen can be detected with a high sensitivity by surface enhanced Raman spectroscopy, and the Raman spectrum signal of a specimen having a normalized signal intensity can be detected without regard to the intensity of the enhanced electric fields occurring at the detection surface of a microstructure. Thus, a specimen can be identified and the quantity and concentration can be detected with a high accuracy and a high precision.

Further, since the Raman spectrum signal of a specimen having a normalized signal intensity can be detected without regard to the intensity of the enhanced electric fields occurring at the detection surface of a microstructure, great tolerances for manufacturing errors of the microstructure can be allowed, improving the yield while reducing the manufacturing costs.

What is claimed is:

1. A method of detecting a Raman spectrum comprising:
a liquid sample contacting step of placing a liquid sample containing a reference substance and a specimen in contact with a detection surface, the reference substance generating a known Raman spectrum having at least one peak therein that is different from peaks in a Raman spectrum generated by the specimen;
a scattered light detecting step of irradiating the detection surface in contact with the liquid sample with an excitation light and detecting Raman scattered light occurring from the liquid sample; and
a normalizing step of extracting a Raman spectrum signal of the reference substance and a Raman spectrum signal of the specimen from the signal detected in the scattered light detecting step and normalizing a signal intensity of the Raman spectrum signal of the specimen according to an intensity of the Raman spectrum signal of the reference substance.

2. The method of detecting a Raman spectrum according to claim 1, wherein normalization is performed in the normalizing step according to the Raman spectrum signal of the reference substance and the Raman spectrum signal of the specimen obtained from a same region of the detection surface.

3. The method of detecting a Raman spectrum according to claim 1, wherein normalization is performed in the normalizing step according to the Raman spectrum signal of the reference substance and the Raman spectrum signal of the specimen simultaneously obtained from a same region of the detection surface.

4. The method of detecting a Raman spectrum according to claim 1, further comprising a drying step of drying the detection surface in contact with the liquid sample before performing the scattered light detecting step.

5. The method of detecting a Raman spectrum according to claim 1, wherein the reference substance is a substance that generates the Raman spectrum having a full-width at half-maximum different from a full-width at half-maximum of the Raman spectrum generated by the specimen.

6. A method of detecting a Raman spectrum comprising:
a first liquid sample contacting step of placing a first liquid sample containing a reference substance generating a known Raman spectrum in contact with a detection surface;
a first scattered light detecting step of irradiating the detection surface in contact with the first liquid sample with an excitation light and detecting a first Raman scattered light occurring from the first liquid sample as a first Raman spectrum signal;
a second liquid sample contacting step of placing a second liquid sample containing a specimen in contact with the detection surface;
a second scattered light detecting step of irradiating the detection surface in contact with the second liquid sample with the excitation light and detecting a second Raman scattered light occurring from the second liquid sample in and close to a same region, wherefrom the first scattered light is detected in the first scattered light detecting step, as a second Raman spectrum signal; and
a normalizing step of normalizing a signal intensity of the second Raman spectrum signal of the specimen detected in the second scattered light detecting step according to a signal intensity of the first Raman spectrum signal of the reference substance detected in the first scattered light detecting step.

7. A device for detecting a Raman spectrum comprising:
a substrate having a detection surface formed thereon that generates enhanced fields upon irradiation of an excitation light;
liquid sample contacting means that places a liquid sample containing a reference substance and a specimen in contact with the detection surface of the substrate, the reference substance generating a known Raman spectrum having at least one peak therein that is different from peaks in a Raman spectrum generated by the specimen;
light radiating means that irradiates the detection surface in contact with the liquid sample with the excitation light;
scattered light detecting means that detects the Raman scattered light occurring from the liquid sample irradiated by the excitation signal; and
normalizing means that extracts the Raman spectrum signal of the reference substance and a Raman spectrum signal of the specimen from the signal obtained by the scattered light detecting means and normalizes a signal intensity of the Raman spectrum signal of the specimen according to an intensity of the Raman spectrum signal of the reference substance.

8. A device for detecting a Raman spectrum according to claim 7, wherein the normalizing means further identifies the specimen from an intensity of a normalized Raman spectrum signal of the specimen and calculates a quantity of the specimen and a concentration thereof in the liquid sample.
